(19) United States
(12) Patent Application Publication
(10) Pub. No.: US 2023/0023890 A1
(43) Pub. Date: Jan. 26, 2023

(54) PERSONAL STIMULATION DEVICE

(71) Applicant: Uccellini Inc., Bend, OR (US)

(72) Inventors: Lora LeeAnne Haddock DiCarlo, Bend, OR (US); Wesley Donal Adreon, Bend, OR (US); Avery Dawn Smith, Albany, OR (US); Blake Michael Larkin, Eugene, OR (US); Ryan Peter Riehl, Bend, OR (US); Kim Porter Henneman, Bend, OR (US); Douglas S. Layman, Bend, OR (US); Mark Hazelton, Philomath, OR (US)

(21) Appl. No.: 17/383,680

(22) Filed: Jul. 23, 2021

(51) Int. Cl. A61H 19/00; A61H 9/00

(52) U.S. Cl. CPC A61H 19/34; A61H 9/0071; A61H 2201/501; A61H 2201/5097; A61H 2201/1207

(57) ABSTRACT

Disclosed embodiments provide an improved stimulation device. Embodiments of the improved stimulation device include a cup and a driver. The cup has a cavity surrounded by a rim. In use, a user positions the rim such that an opening to the cavity is over an area of a user's body to be stimulated (for example, the clitoris). A sealed-, or substantially-sealed, main chamber is formed by the cavity walls and the user's body (skin surrounding the clitoris). A pressure field is generated in the main chamber. The device includes a voice coil motor that drives a linear actuator. This enables the volume of the cavity, and changes in volume, to be electronically controlled. The change in total volume causes a change in pressure experienced by the user. This allows the user to adjust the pressure based on comfort and pleasure as per user preferences.

### FIELD

Embodiments of the invention relate to a stimulation device, and more particularly, to an air pressure field stimulation device.

### BACKGROUND

Stimulation of skin has many beneficial effects, including raising blood flow in the area, and stimulating nerve endings. In addition, on a human body, a vulva includes organs including a clitoris, mons pubis, labia majora, and labia minora surrounding the vagina. The glans clitoris is a portion of the clitoris that is on the vulva, external to the vagina. The glans clitoris is sexually responsive, having thousands of nerve endings. The vulva (and vagina) is sexually responsive as well. Stimulation of a person's glans clitoris increases blood flow to the area and provides sexual pleasure. There exists a need for improvements in personal massagers that can provide increased stimulation.

### SUMMARY

In one embodiment, there is provided a stimulation device comprising: a cup comprising a cavity; a driver, wherein the driver comprises: a voice coil motor comprising an extendable actuator, wherein the extendable actuator is affixed to an underside surface of the cup; a processor; and a memory, wherein the memory contains instructions, that when executed by the processor, cause the driver to intermittently change a volume of the cavity of the cup from a first volume to a second volume.

In another embodiments, there is provided a stimulation device comprising: a cup comprising a cavity; a plurality of inward-facing protrusions disposed on an inner side surface of the cup; a driver, wherein the driver comprises: a voice coil motor comprising an extendable actuator, wherein the extendable actuator is affixed to an underside surface of the cup; a processor; and a memory, wherein the memory contains instructions, that when executed by the processor, cause the driver to intermittently change a volume of the cavity of the cup from a first volume to a second volume.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1A shows a perspective view of an additional embodiment of the present invention comprising dual interconnected chambers with adjustable volume capability.

FIG. 1B is a side view of the embodiment of FIG. 1A.

FIG. 1C is a front view of the embodiment of FIG. 1A.

FIG. 1D is a top-down view of the embodiment of FIG. 1A.

FIG. 1E is a back view of the embodiment of FIG. 1A.

FIG. 1F is a bottom-up view of the embodiment of FIG. 1A.

FIG. 2A is a cutaway side view illustrating mechanical components.

FIG. 2B is a cutaway top-down view illustrating mechanical components.

FIG. 3 is a cutaway view including the outer covering and illustrating the dual interconnected chambers with adjustable volume capability in accordance with disclosed embodiments.

FIG. 4A shows a portion of a massager device with an auxiliary chamber in an increased volume configuration.

FIG. 4B shows a portion of a massager device with an auxiliary chamber in a decreased volume configuration.

FIG. 5A shows a portion of a massager device with an actuator in an increased volume configuration in accordance with additional embodiments.

FIG. 5B shows a portion of a massager device with an actuator in a decreased volume configuration in accordance with additional embodiments.

FIG. 6 is a block diagram indicating electronic components of disclosed embodiments.

FIG. 7A is a perspective view of an additional embodiment.

FIG. 7B is a sectional view of the embodiment of FIG. 7A.

FIG. 7C is a front view of the embodiment of FIG. 7A.

FIG. 7D is a side view of the embodiment of FIG. 7A.

FIG. 7E is a bottom view of the embodiment of FIG. 7A.

FIG. 7F is a back view of the embodiment of FIG. 7A.

FIG. 8A is a perspective view of an embodiment utilizing cup protrusions.

FIG. 8B shows details of a cup protrusion.

FIG. 8C is a top-down view of the embodiment of FIG. 8A.

FIG. 9 is a cutaway view of a massager device with an actuator and cup protrusions.

FIG. 10 is a cutaway view of a massager device with dual interconnected chambers with adjustable volume capability and cup protrusions.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide an improved stimulation device. Embodiments of the improved stimulation device include a cup and a driver. The cup has a cavity surrounded by a rim. In use, a user positions the rim such that an opening to the cavity is over an area of a user's body to be stimulated (for example, the clitoris). A sealed-, or substantially-sealed, main chamber is formed by the cavity walls and the user's body (skin surrounding the clitoris). A pressure field is generated in the main chamber. The device may further include an auxiliary chamber that is pneumatically connected to the main chamber via a conduit. An auxiliary chamber volume adjuster allows the user to vary the volume of the auxiliary chamber, which varies a total combined volume of the pneumatically connected main chamber and auxiliary chamber. The change in total volume causes a change in pressure experienced by the user. This allows the user to adjust the pressure based on comfort and pleasure as per user preferences. In some embodiments, the stimulation device is a sex toy. In some embodiments, the stimulation device is a medical device.

Reference throughout this specification to “one embodiment,” “an embodiment,” “some embodiments”, “embodiments,” or similar language means that a particular feature, structure, or characteristic described in connection with the embodiment is included in at least one embodiment of the present invention. Thus, appearances of the phrases “in one embodiment,” “in an embodiment,” “in some embodiments”, “in embodiments,” and similar language throughout this specification may, but do not necessarily, all refer to the same embodiment.

Moreover, the described features, structures, or characteristics of the invention may be combined (“mixed and matched”) in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, and/or elements.

For the purposes of disclosure, the word, “substantially” is defined as “for the most part”. It means “to a great extent,” but having some room for some minor variation.

Throughout this disclosure, a legend is used to indicate orientation of the various views of disclosed embodiments with respect to an X, Y, and Z axis.

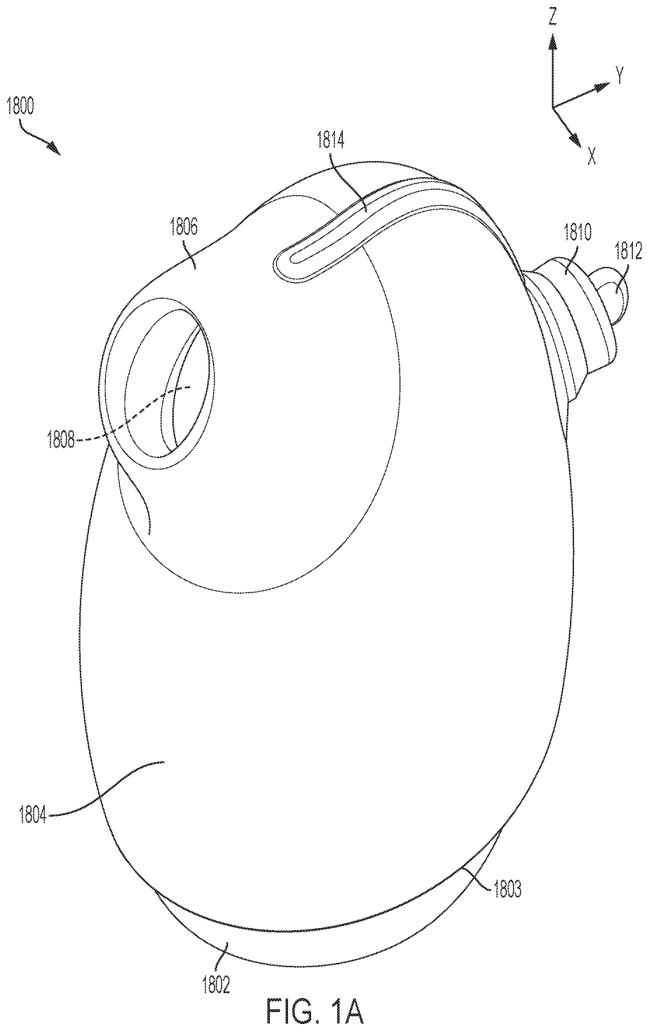

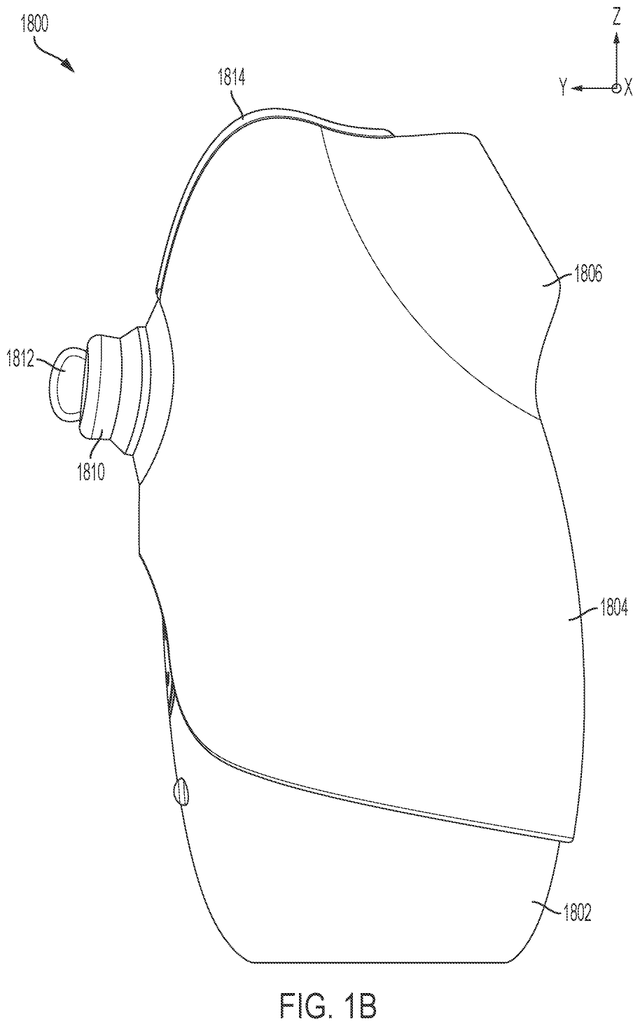

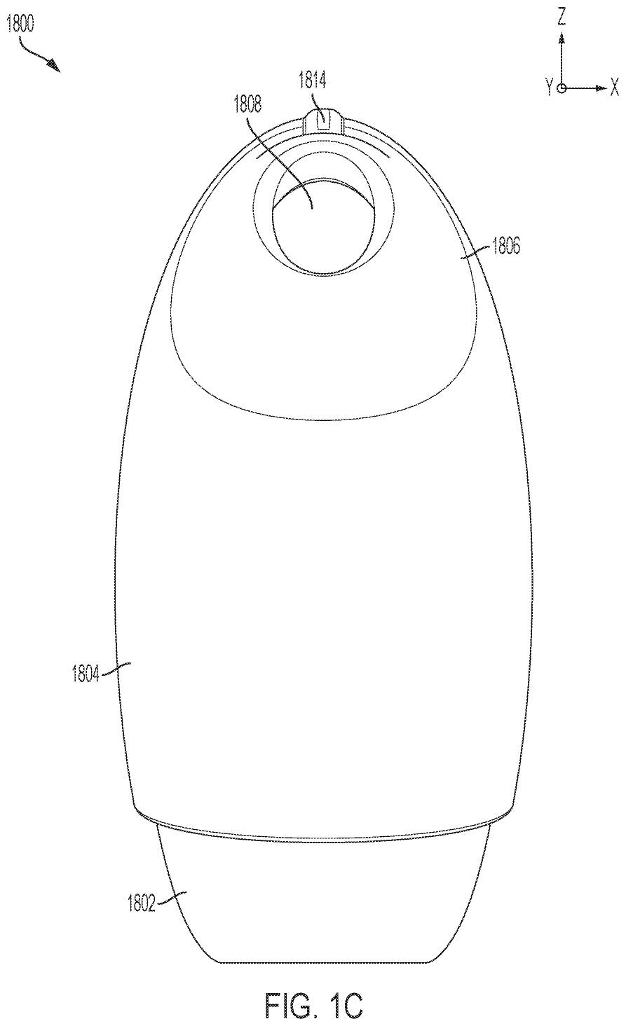

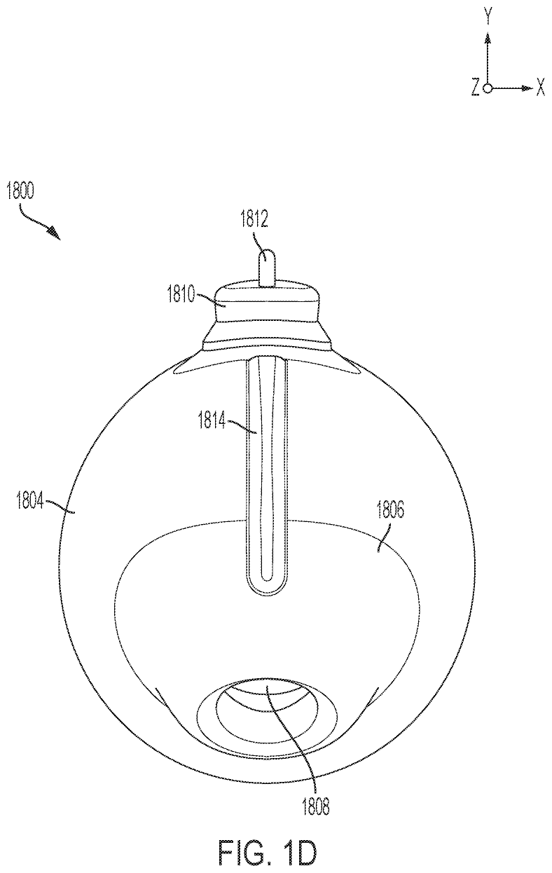

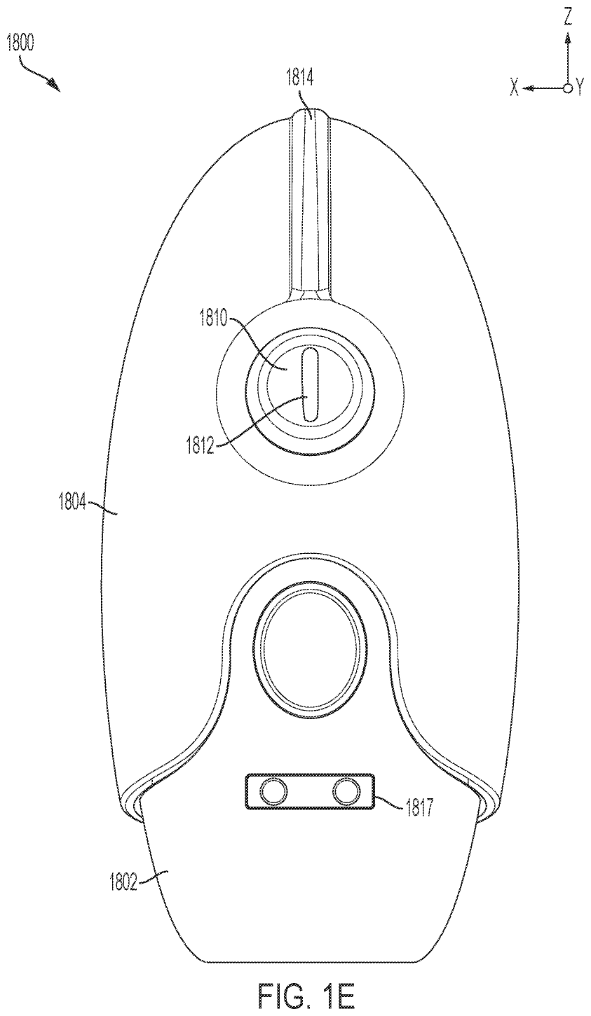

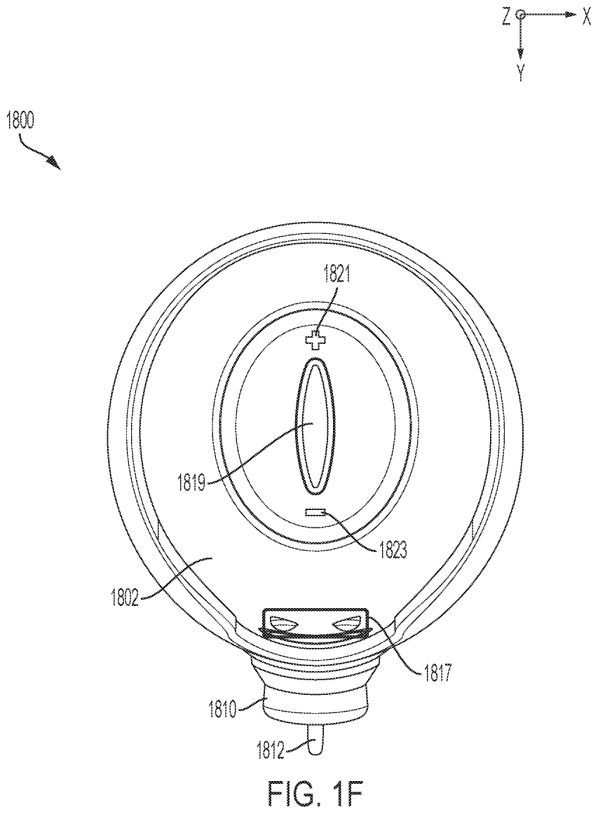

FIG. 1A shows a perspective view of an embodiment of the present invention comprising dual interconnected chambers with adjustable volume capability. FIG. 1B is a side view of the embodiment of FIG. 1A. FIG. 1C is a front view of the embodiment of FIG. 1A. FIG. 1D is a top-down view of the embodiment of FIG. 1A. Massager 1800 comprises an enclosure 1802. A sleeve 1804 is placed over the enclosure 1802 such that the sleeve 1804 forms an essentially air-tight fit over the enclosure at the base 1803 of the sleeve 1804. The sleeve has a shroud 1806 with an opening 1808 that is applied against the body of a user during operation of the massager 1800 to apply a pressure to the skin in that area. An auxiliary chamber 1810 is connected to the opening 1808 via conduit 1814. The auxiliary chamber volume is adjustable via tab 1812. The tab 1812 can be pushed in or pulled out to vary the volume of the auxiliary chamber 1810.

FIG. 1E is a back view of the embodiment of FIG. 1A. In this view, the charging port 1817 can be seen. In some embodiments, a magnetic charging port may be used. Other embodiments may use an electrical connector such as a USB-C connector or equivalent to recharge an internal rechargeable battery.

FIG. 1F is a bottom-up view of the embodiment of FIG. 1A. In this view, a speed control 1819 can be seen. The speed control 1819 may be pushed towards the plus marker 1821 to increase the speed of the cup oscillations of the device, or pushed towards the minus marker 1823 to reduce the speed of the cup oscillations of the device, according to preference of the user. The plus and minus markers are used here for description, and other designations may be substituted within the scope of the invention. In addition, the button may be a different size, may be more than one button, or may not be present as the device may be remote-controlled.

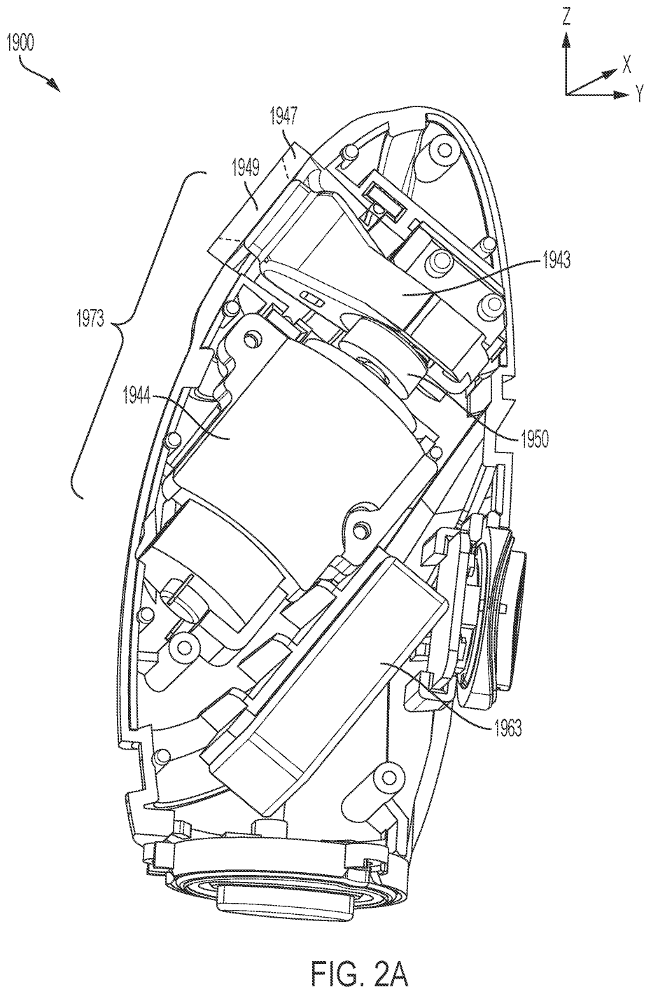

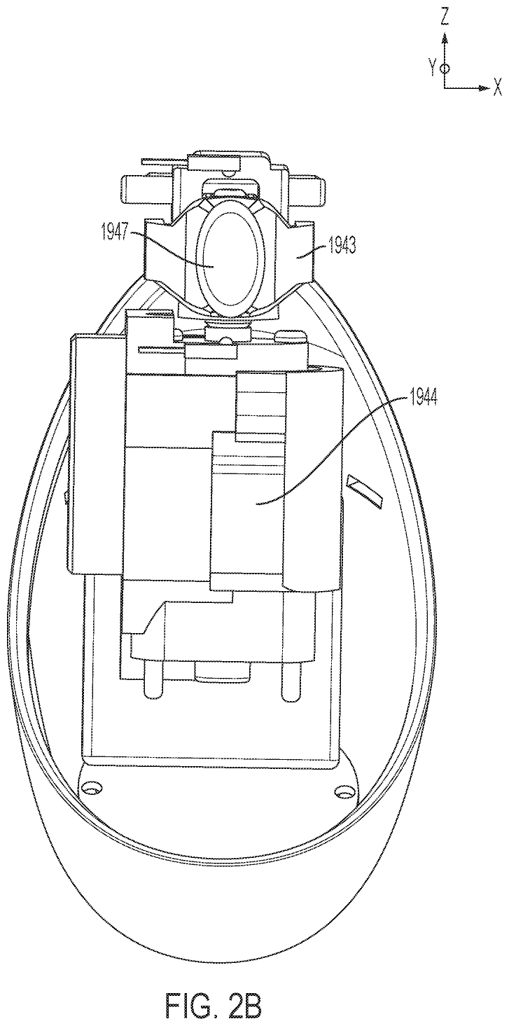

FIG. 2A is a cutaway side view of a massager device 1900 similar to massager 1800 illustrating mechanical components. FIG. 2B is a cutaway top-down view of the device 1900 shown in FIG. 2A. Massager device 1900 has a cup volume driver 1973 to operate a cup to provide pressure variations, and includes motor 1944 and cam 1950. Cup volume driver 1973 is configured and disposed to intermittently change the volume of cup 1947. Cup volume driver 1973 includes motor 1944, cam 1950, and cup linkage. Motor 1944 may be a DC motor in some embodiments. Cam 1950 may be round, oval, or other suitable shape. A rechargeable battery 1963 is used to power the massager device 1900. Cup linkage 1943 is affixed to an underside of cup 1947. As the motor operates, the cup linkage 1943 alternatingly pulls and pushes on the cup underside, causing variation in the volume of the cavity 1949 formed within the cup 1947. Accordingly, pressure is varied inside the cup when the cup is sealed or substantially-sealed (against a user's body), which can create a pleasurable sensation for a user. Note that the cup volume driver herein is provided for purposes of disclosure. In implementation, the driver may have more or different components. Any suitable cup volume driver may be substituted within the scope of embodiments of the invention.

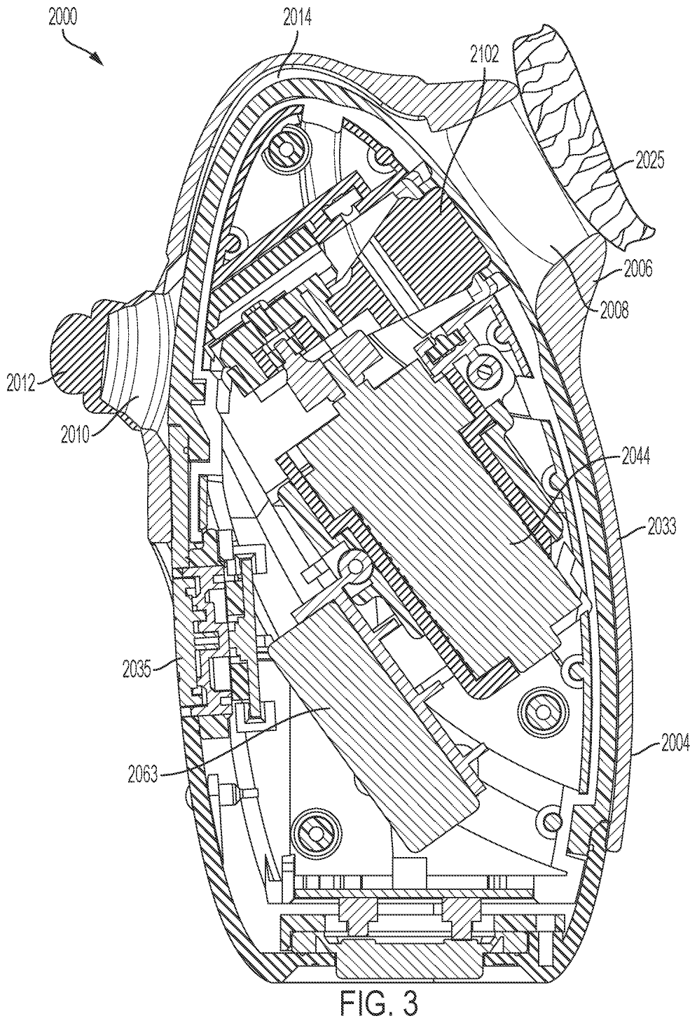

FIG. 3 is a cutaway view of a massager device 2000 similar to massager 1800, including the outer covering sleeve 2004 and illustrating the dual interconnected chambers with adjustable volume capability in accordance with disclosed embodiments. As can be seen in FIG. 3, the battery 2063 and motor 2044 are shown. The shroud 2006 of device 2000 is placed firmly against the skin, represented at 2025, of a user. This forms a chamber 2008 inside the cup (cavity) substantially sealed off by user's skin 2025. Chamber 2008 has a first volume Vm. A conduit 2014 connects main chamber 2008 to auxiliary chamber 2010, having a volume Va. Air can flow between chamber 2008 and chamber 2010 via conduit 2014, pneumatically connecting the two chambers. The total combined volume of both chambers is Vt, where Vt=Vm+Va. The user can adjust the volume of the auxiliary chamber Va by manipulating the tab 2012. In embodiments, when the opening of the cavity is placed over a skin surface of a user, a main chamber is formed, and a pressure field is generated that varies inversely with the second volume.

As the driver (1973 of FIG. 2A) operates, it pulls the underside of the cup 2102 which creates pressure on skin 2025 of the user. The pressure is inversely proportional to the total volume Vt. In the embodiment of FIG. 3, the main chamber 2008 is disposed on a first side 2033 of the massager device 2000 and the auxiliary chamber 2010 is on a second side 2035 of the massager device 2000. In embodiments, the second side 2035 is opposite the first side 2033. This arrangement allows the user the ability to conveniently adjust the volume Va of the auxiliary chamber 2010 while the main chamber 2008 is pressed against the user's body. In embodiments, the volume adjustment of the auxiliary chamber 2010 is accomplished by pushing the tab 2012 to reduce the volume Va, or pulling the tab 2012 to increase the volume Va. The pressure is inverse to the total volume Vt. Thus, when the user pushes the tab 2012 in, it reduces the volume Va, and thus the total volume Vt is reduced. This increases the pressure within chamber 2008 as pressure varies inversely with volume.

Conversely, when the user pulls tab 2012, it increases volume Va, which in turn increases volume Vt, lowering the pressure within chamber 2008. Thus, embodiments allow the user to adjust the volume Vt, thereby adjusting the pressure experienced on skin 2025 of the user. The pressure can be changed during operation. Thus, as an example, a user can start use of the device with a lower pressure, and then build up to an increased pressure during use, based on preference and comfort of the user. Conversely, a user could also start use of the device with a higher pressure, and then reduce pressure to a decreased pressure during use, based on preference and comfort of the user.

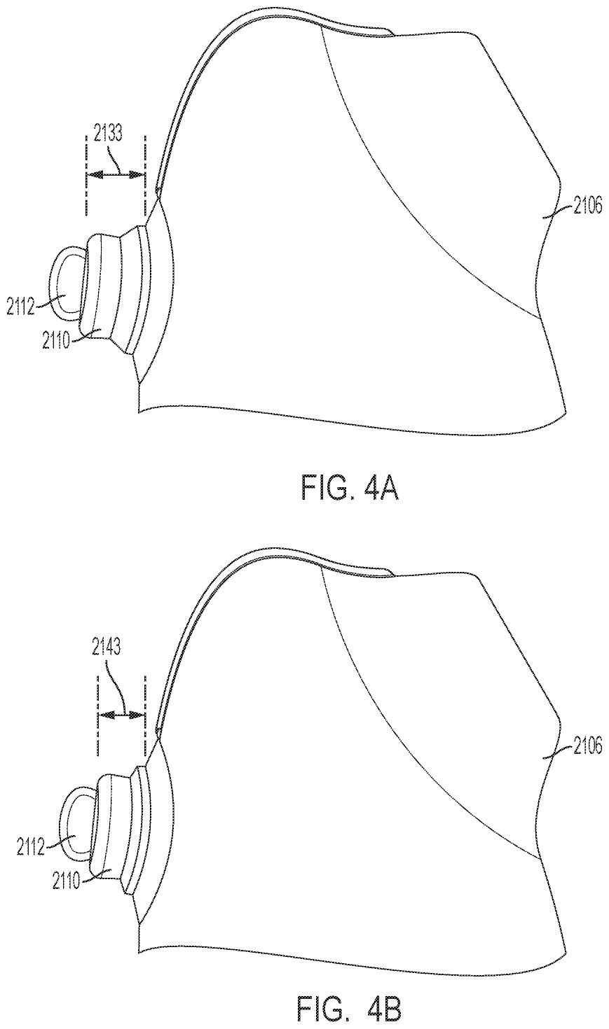

FIG. 4A shows a portion of a massager device with an auxiliary chamber in an increased volume configuration. FIG. 4B shows a portion of a massager device with an auxiliary chamber in a decreased volume configuration. Referring now to FIG. 4A, the tab 2112 is shown in a pulled-out configuration, expanding auxiliary chamber 2110 to have a depth 2133. This creates an increased total volume between the auxiliary chamber and the main chamber, such that when the shroud 2106 is placed firmly against a user's skin as to create an air-tight seal, a minimal pressure is applied against the skin of the user. Referring now to FIG. 4B, the tab 2112 is pushed in, compressing auxiliary chamber 2110 to have a depth 2143, where depth 2143 is less than depth 2133 of FIG. 4A. This creates a decreased total volume between the auxiliary chamber and the main chamber, such that when the shroud 2106 is placed firmly against a user's skin as to create a seal or substantial seal, a maximum pressure is applied against the skin of the user.

In embodiments, the auxiliary chamber 2110 is expandable and collapsible using a flexible resilient material such as silicone to mold over-center hinges within the adjacent volume walls. This allows the volume of the auxiliary chamber to be set to a desired volume, and then the user can let go of the tab and the tab remains in the position set by the user. In embodiments, the auxiliary chamber volume adjuster comprises a tab configurable to be pulled and pushed to adjust the second volume.

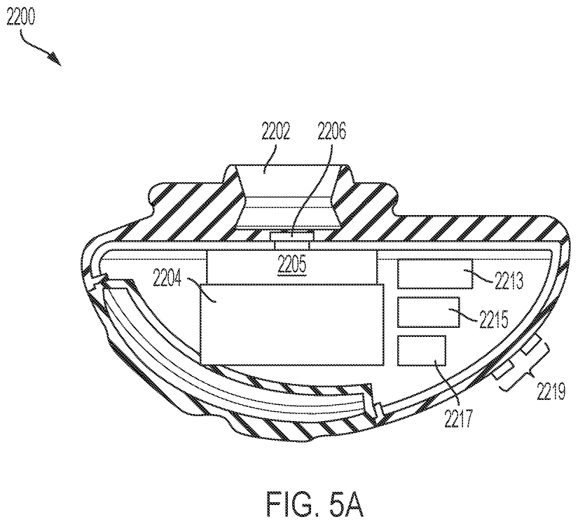

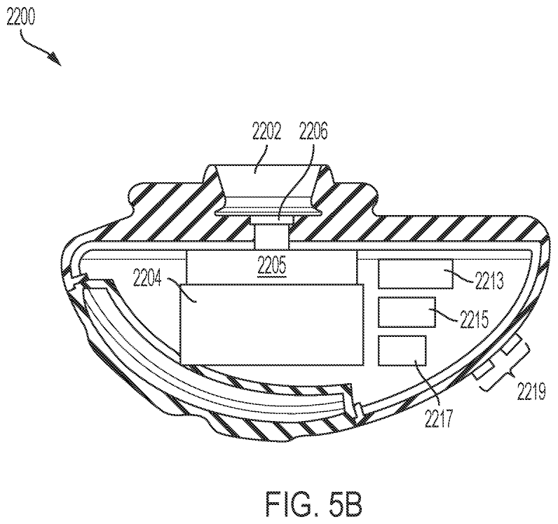

FIG. 5A shows an alternative embodiment of the present invention in an increased volume configuration. In this embodiment, a cup 2202 is operated by a voice coil motor 2204 that drives a linear actuator 2206. FIG. 5B shows the embodiment of FIG. 5A in a decreased volume configuration. In this embodiment, the cup volume driver may include the same components as those shown in FIGS. 2A and 2B, or another may be substituted. As shown in FIG. 5B, the actuator 2206 is extended, which reduces the volume within cup 2202. In embodiments, the user can select a volume of cup 2202 by adjusting the amount of extension of actuator 2206 prior to placing the cup 2202 firmly against his/her skin. The maximum pressure experienced by the user is a function of the starting volume.

The stroke length of the actuator 2206 can also be controlled and/or adjusted during operation in some embodiments. In embodiments, the actuator 2206 is electromagnetic and operates by using a copper coil energized by an electric current and one or more permanent magnets. The force generated by the coil is proportional to the magnetic field and the direction and magnitude of the electric current. The level of electric current can change the position of the actuator. Switching the direction of the current changes the direction of the force. In embodiments, the voice coil motor comprises an extendable actuator, and the extendable actuator is affixed to an underside surface of the cup.

A processor 2215 executes instructions stored in memory 2217 to implement functionality of disclosed embodiments. The memory 2217 may be a non-transitory computer-readable medium including random-access memory (RAM), flash, static random-access memory (SRAM), or other suitable memory type. An internal battery 2213 may be used to power the processor 2215, actuator 2206, and other electronic components. By manipulating user interface 2219, which may include one or more buttons or switches that effect electronic control circuits prior to the user applying the device to the body part, the user can adjust the starting volume by activating the coils' energy to move the actuator's starting position. The current moves the actuator to a configuration such as shown in FIG. 5B to cause a smaller starting volume of cup 2202. To operate the device, the user can increase the current to collapse the cup further. The pressure the user experiences is proportional to the change in volume of the cup. The smaller starting volume leads to smaller pressure changes between the minimum pressure and the maximum pressure.

Using the processor 2215 coupled to electronic control circuits 2205, the user can adjust the cup's volume during use by activating the energy in the coils to locate the actuator's ending position. The user chooses a smaller stroke for a smaller change in volume and a larger stroke for a larger volume change. In embodiments, a memory contains instructions, that when executed by the processor, cause the driver to adjust a range of motion of the extendable actuator. In embodiments, the electronic current can be pulsed to allow the user to adjust the frequency of the stimulation.

Thus, the disclosed allow for enhanced control over the operation of the massager device by allowing adjustment of the pressure. In embodiments, by controlling the operation of the actuator 2206, the user can control the initial volume of the cup 2202. The initial volume affects how much pressure is applied during operation. Additionally, in embodiments, user can specify the maximum and/or minimum volumes of the cup 2202. In embodiments, this is accomplished by specifying a range of travel for the actuator 2206. By specifying a maximum and minimum range, the range of volume change, and thus, the range of pressures felt by the user, can be controlled by the user, enabling a customized user experience. Additionally, the operational speed of the voice coil motor 2204 may be controlled by the user, thereby allowing control of the rate of change of the cup's volume. This can provide improved pleasure and comfort for a user of disclosed embodiments.

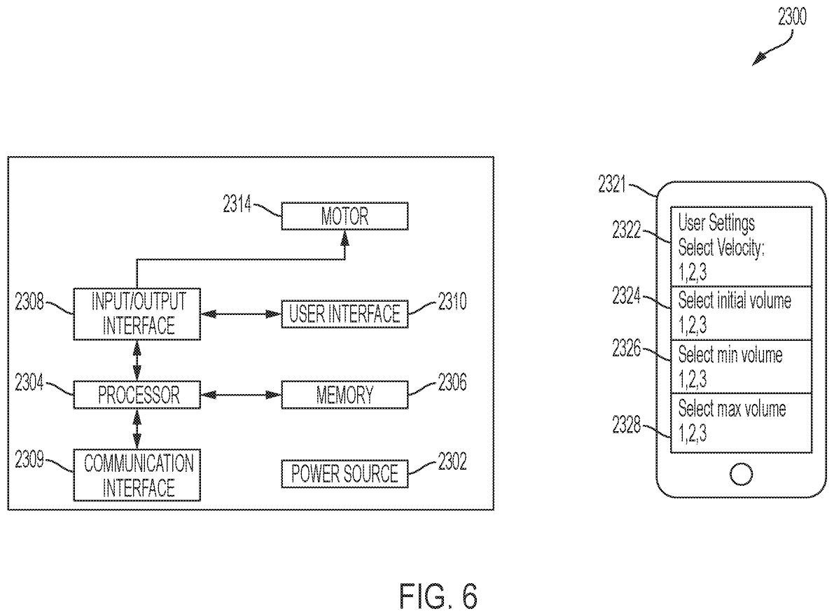

FIG. 6 is a block diagram showing components of an embodiment of the present invention. Diagram 2300 includes a processor 2304 and a memory 2306 coupled to the processor 2304, an input/output (I/O) interface 2308 coupled to the processor 2304, and a user interface 2310 coupled to the I/O interface 2308.

A power source 2302 powers the processor 2304, motor 2314, and other electronic components. Power source 2302 may be a battery, which may be a replaceable, or internally sealed rechargeable battery. In some embodiments, the battery may be USB-chargeable, inductively chargeable, or other suitable charging mechanism now known or hereafter developed. It should be recognized that any power source, now known or hereafter developed, may be used. More than one battery may be included in some embodiments. In some embodiments, the stimulation device may be powered by alternating current power, such as 120V or 240V standard household power, with a power adapter comprising voltage regulators to convert the power to an appropriate DC level (e.g. 12V DC).

The memory 2306 may include a non-transitory computer readable medium including, but not limited to, flash, EEPROM, static ram (SRAM), or other suitable storage type. The memory 2306 contains instructions, that when executed by processor 2304, enable embodiments of the present invention. The user interface 2310 may comprise one or more buttons, lights, buzzers, liquid crystal displays, and/or other suitable components for control and operation of the device.

The massager device further includes motor 2314. The direction of movement of motor 2314 may be controlled via a signal from input/output interface 2308. The device may further include a communication interface 2309, which may support a wired and/or wireless communication protocol, including, but not limited to, Wi-Fi, Bluetooth, infrared, or other suitable communication protocol. Thus, in embodiments, the communication interface 2309 is a wireless communication interface. In some embodiments, the communication interface 2309 includes a Bluetooth transceiver. In some embodiments, the communication interface 2309 includes a Wi-Fi transceiver. In some embodiments, the user interface 2310 may not be present.

The communication interface 2309 can enable communication with a remote device 2321 such as a smartphone or tablet computer to enable additional user interface functions on the remote device. In some embodiments, the massager device may be controllable via an application on the remote device 2321, instead of, or in addition to user interface 2310.

In some embodiments, a user interface rendered on remote device 2321 may include additional options. In embodiments, the additional options include a speed setting 2322. The speed setting may have various available levels (e.g., level 1, 2, and 3). Each level may correspond to a different operational speed of motor 2314. In embodiments, the additional options include an initial cup volume setting 2324. The initial cup volume setting may have various available levels (e.g., option 1, 2, and 3). In embodiments, the additional options include a minimum cup volume setting 2326. The minimum cup volume setting may have various available levels (e.g., option 1, 2, and 3). In embodiments, the additional options include a maximum cup volume setting 2328. The maximum cup volume setting may have various available levels (e.g., option 1, 2, and 3). These settings may be stored in memory 2306, such that the preferences of the user are saved and retrieved on subsequent uses of the device.

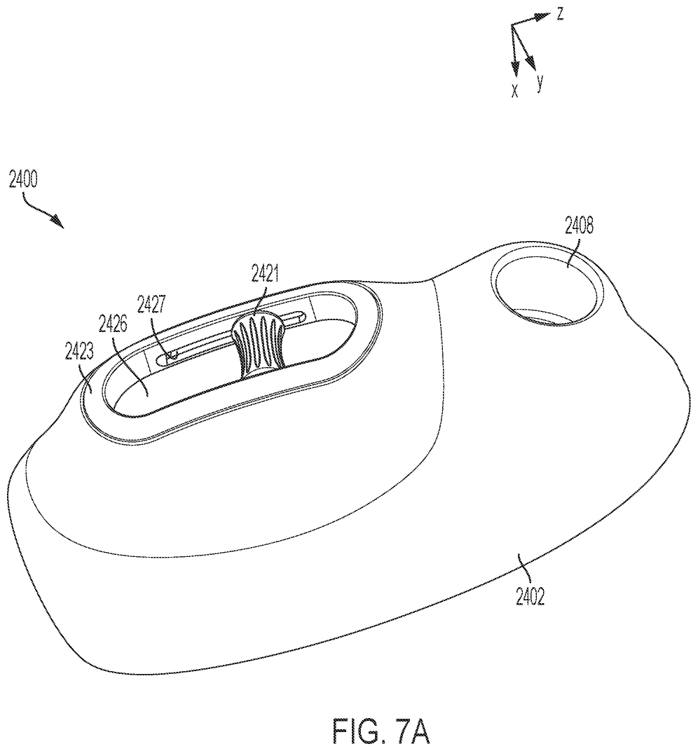

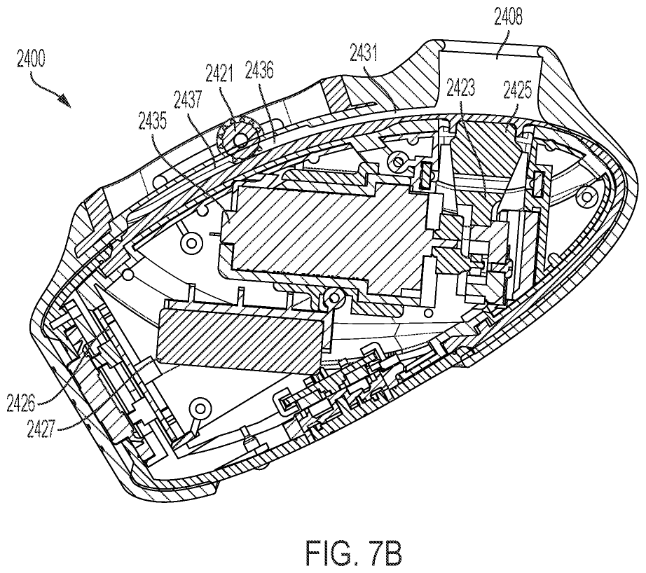

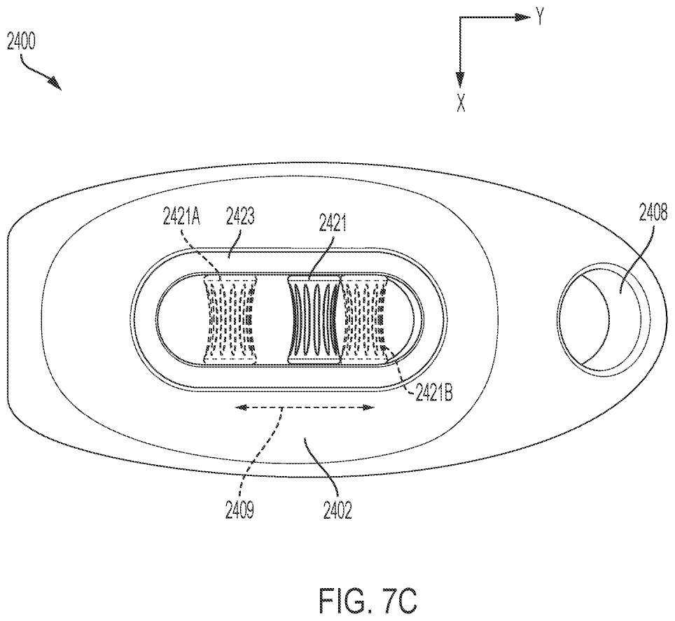

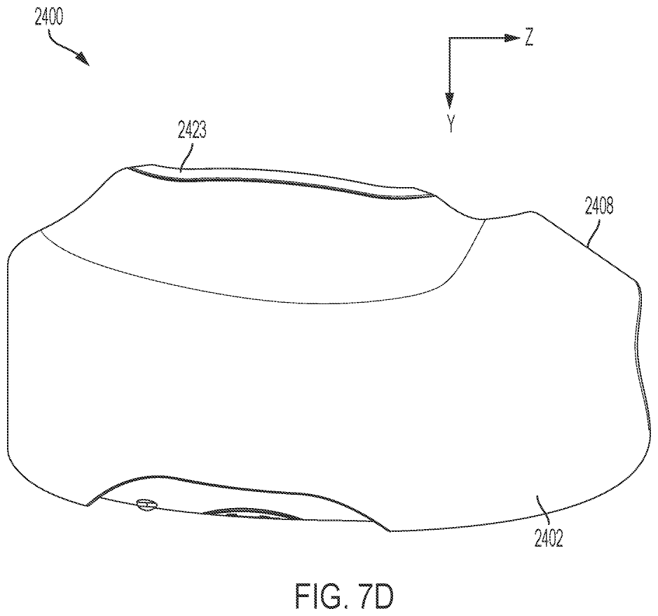

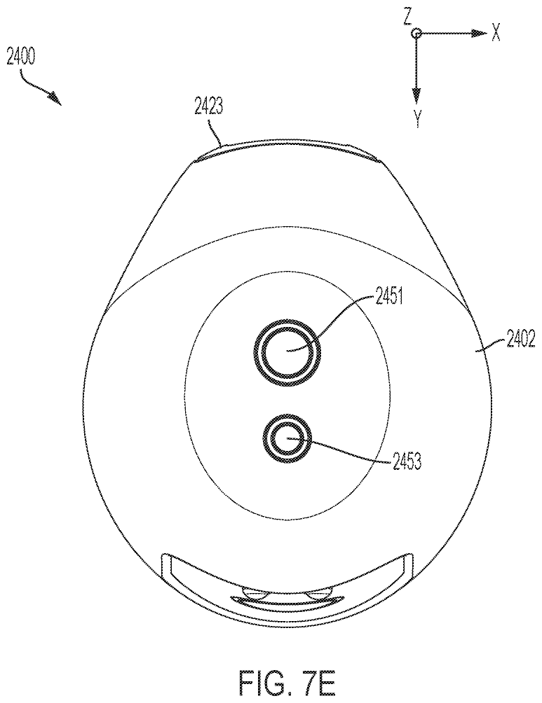

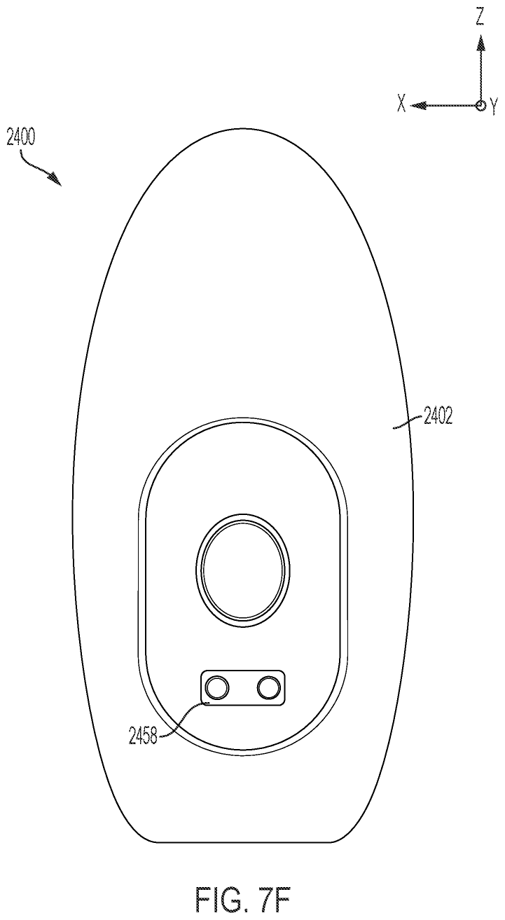

FIG. 7A is a perspective view of an additional embodiment of a massager device 2400. This embodiment has some similarities to that shown in FIG. 1A, with a main difference being the mechanical arrangement for selecting the size of the auxiliary chamber. Massager 2400 comprises an enclosure 2402. Device 2400 includes an opening 2408 that is applied against the body of a user during operation of the massager 2400 to apply a pressure to the skin in that area.

Device 2400 includes a roller 2421. The roller 2421 is mechanically engaged with slot 2427 formed in frame 2423. The roller is configured to press against chamber surface 2426 with sufficient pressure to seal off a portion of the underlying chamber. The opposing force exerted by the chamber surface 2426 against the roller 2421 provides friction that maintains the roller 2421 in a given position.

FIG. 7B is a sectional view of the embodiment of FIG. 7A. In this view, a cup 2425 is shown disposed adjacent to opening 2408. A motor 2435 is mechanically coupled to the cup 2425. Cup 2425 may be similar to cup 1947 of FIG. 2A. Motor 2435 is mechanically coupled to cup linkage 2424. Cup linkage 2424 may be similar to cup linkage 1943 of FIG. 2A. A processor 2426 may be used to control operation of the motor 2435.

The roller 2421 is shown in an intermediate position. Conduit 2431 pneumatically connects main chamber (opening 2408), to the auxiliary chamber 2436, utilizing principles similar to those shown and described for FIG. 3. The roller 2421 forms a seal, isolating section 2437 from the main chamber. The position of the roller is adjustable by the user to alter the size of auxiliary chamber 2435, thereby providing an enhanced level of control for the device 2400.

FIG. 7C is a front view of the embodiment of FIG. 7A. In this view, the roller 2421 is shown in an intermediate position. The user can operate the roller 2421 by moving it in the directions indicated by arrow 2409, bounded by frame 2423. The user can move the roller 2421 to a maximum position as indicated at 2421A. When in this position, the volume of the auxiliary chamber is maximized. The user can move the roller 2421 to a minimum position as indicated at 2421B. When in this position, the volume of the auxiliary chamber is minimized. Thus, in embodiments, the roller 2421 is configurable to be moved in a linear path (as indicated by arrow 2409) in order to adjust the auxiliary chamber volume.

FIG. 7D is a side view of the embodiment of FIG. 7A showing the frame 2423 and opening 2408 and enclosure 2402. FIG. 7E is a bottom view of the embodiment of FIG. 7A. In this view, user controls 2451 and 2453 are shown. In embodiments, the user controls are buttons. In embodiments, button 2451 may be used to increase the speed of the motor 2435, and button 2453 may be used to decrease speed of the motor 2435. In some embodiments, button 2451 may also function as an on/off switch by pressing and holding for a predetermined time duration (e.g., three seconds).

FIG. 7F is a back view of the embodiment of FIG. 7A. In this view, a charging port 2458 is shown. The charging port 2458 may be used to charge the internal battery 2427. Charging port 2458 may be a USB port, USB-C port, or other suitable connecter type to receive power from a power source for recharging the device in between uses.

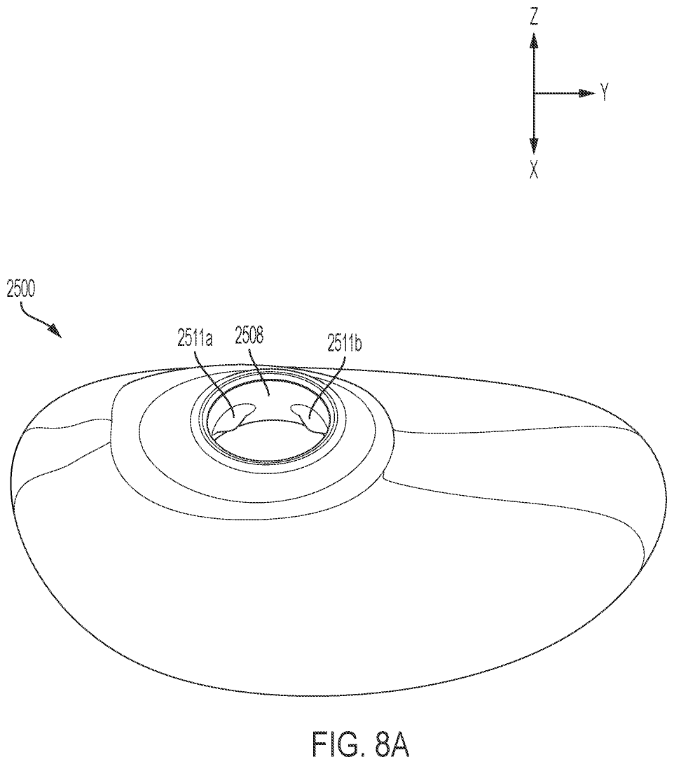

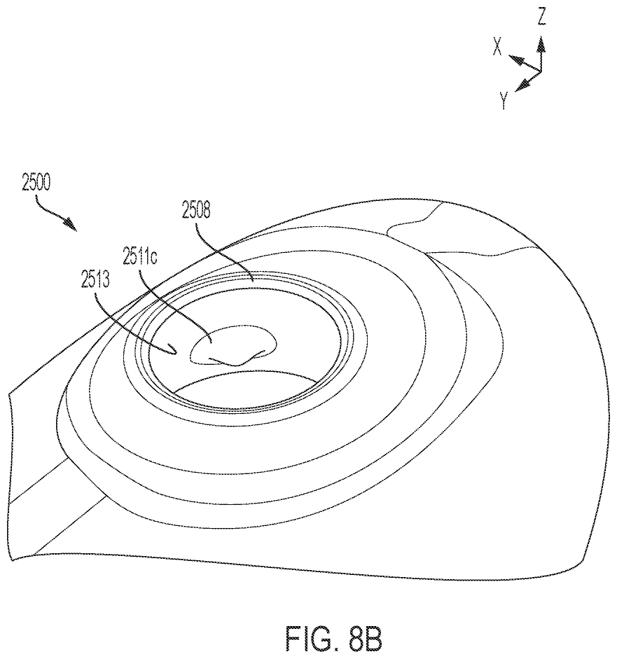

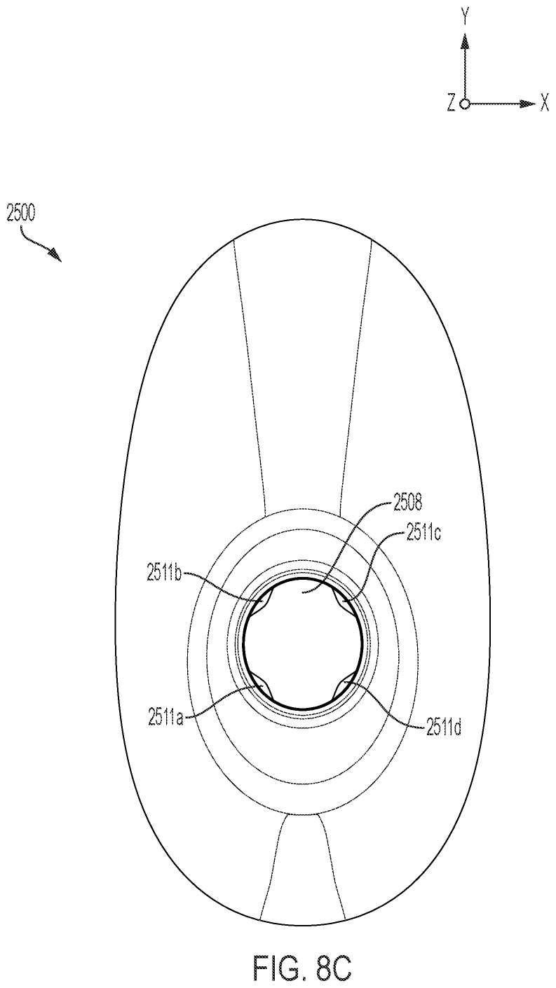

FIG. 8A is a perspective view of an embodiment utilizing cup protrusions. Massager 2500 may be mechanically similar to any of the other embodiments shown in FIGS. 1-7, with a main difference being a plurality of protrusions, those designated 2511a and 2511b in view, formed within opening 2508. FIG. 8B shows details of a cup protrusion 2511c which extends inward from side wall 2513. Benefits of the protrusions include the ability to reduce overall volume while still creating an opening 2508 of suitable size to be placed over the clitoris of a user. FIG. 8C is a top-down view of the embodiment of FIG. 8A. As can be seen in FIG. 8C, there are four inward-facing protrusions 2511a-2511d in opening 2508 of massager 2500. In practice, embodiments can have more or fewer inward-facing protrusions affixed to the inner side wall 2513. This allows fine-tuning of the volume within opening 2508 to allow optimal sizing and volume of the opening 2508 for use with the clitoris of a user.

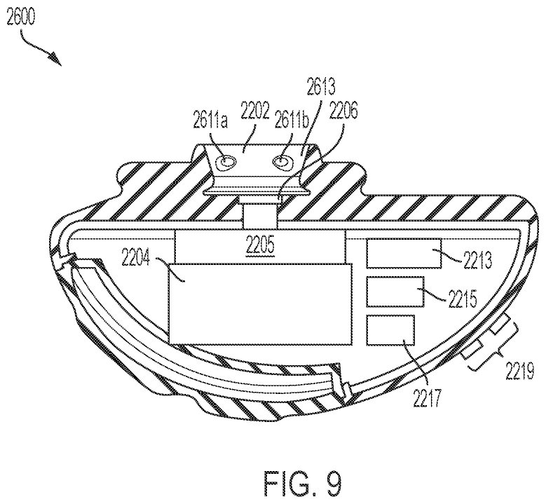

FIG. 9 is a cutaway view of a massager device 2600 with an actuator and cup protrusions 2611a and 2611b protruding from inner side 2613 surface of the cup 2202. Device 2600 is similar to device 2200 of FIG. 5A and FIG. 5B, with a main difference being that massager device 2600 utilizes protrusions such as those shown in FIGS. 8A-8C.

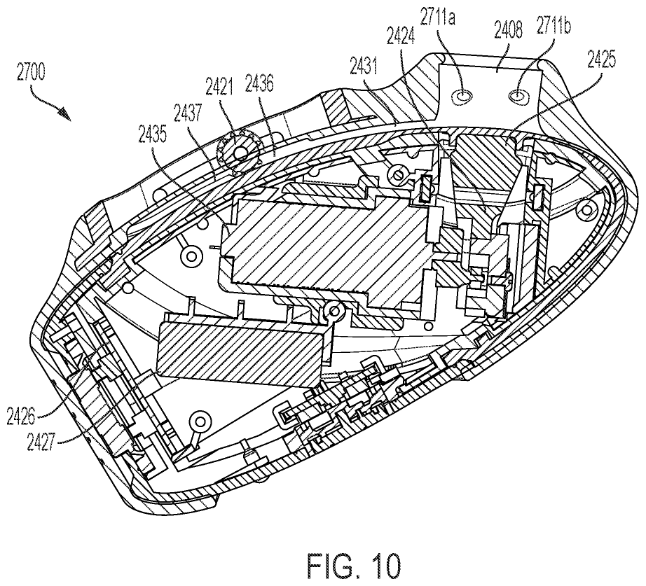

FIG. 10 is a cutaway view of a massager device 2700 with dual interconnected chambers with adjustable volume capability and cup protrusions 2711a and 2711b. Device 2600 is similar to device 2200 of FIG. 5A and FIG. 5B, with a main difference being that massager device 2600 utilizes protrusions such as those shown in FIGS. 8A-8C. Any of the embodiments disclosed herein can be used with or without protrusions.

Unless otherwise noted, components of embodiments may be made of plastic, silicone, metal, composite, or another suitable material.

Some embodiments are waterproof such that they may be washed with fluids, like soap and water. Accordingly, the attachment points of the sheath and any other external portions are sealed where necessary. This allows a user to clean the device thoroughly between uses.

While the invention has been particularly shown and described in conjunction with exemplary embodiments, it will be appreciated that variations and modifications will occur to those skilled in the art. The embodiments according to the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of the invention.

What is claimed is:

1. A stimulation device comprising:
a cup comprising a cavity;
a driver, wherein the driver comprises: a voice coil motor comprising an extendable actuator, wherein the extendable actuator is affixed to an underside surface of the cup;
processor; and
a memory, wherein the memory contains instructions, that when executed by the processor, cause the driver to intermittently change a volume of the cavity of the cup from a first volume to a second volume.

2. The stimulation device of claim 1, wherein the memory contains instructions, that when executed by the processor, cause the driver to adjust a range of motion of the extendable actuator.

3. The stimulation device of claim 2, wherein an initial volume of the cavity is user-selectable.

4. The stimulation device of claim 3, wherein a minimum volume of the cavity is user-selectable.

5. The stimulation device of claim 4, wherein a maximum volume of the cavity is user-selectable.

6. The stimulation device of claim 5, wherein an operational speed of the voice coil motor is user-selectable.

7. The stimulation device of claim 1, wherein the cup comprises a plurality of inward-facing protrusions disposed on an inner side surface of the cup.

8. The stimulation device of claim 1, further comprising a wireless communication interface.

9. The stimulation device of claim 1, wherein the cup is formed of a flexible resilient material.

10. The stimulation device of claim 8, wherein the wireless communication interface includes a Bluetooth transceiver.

11. A stimulation device comprising:
a cup comprising a cavity;
a plurality of inward-facing protrusions disposed on an inner side surface of the cup;
a driver, wherein the driver comprises: a voice coil motor comprising an extendable actuator, wherein the extendable actuator is affixed to an underside surface of the cup;
a processor; and
a memory, wherein the memory contains instructions, that when executed by the processor, cause the driver to intermittently change a volume of the cavity of the cup from a first volume to a second volume.

12. The stimulation device of claim 11, wherein the memory contains instructions, that when executed by the processor, cause the driver to adjust a range of motion of the extendable actuator.

13. The stimulation device of claim 12, wherein an initial volume of the cavity is user-selectable.

14. The stimulation device of claim 13, wherein a minimum volume of the cavity is user-selectable.

15. The stimulation device of claim 14, wherein a maximum volume of the cavity is user-selectable.

16. The stimulation device of claim 15, wherein an operational speed of the voice coil motor is user-selectable.

17. The stimulation device of claim 11, wherein the plurality of inward-facing protrusions comprises four protrusions.

18. The stimulation device of claim 11, further comprising a wireless communication interface.

19. The stimulation device of claim 18, wherein the wireless communication interface includes a Bluetooth transceiver.

20. The stimulation device of claim 11, wherein the cup is formed of a flexible resilient material
